(19) United States
(12) Patent Application Publication
(10) Pub. No.: US 2008/0203702 A1
(43) Pub. Date: Aug. 28, 2008

(54) Wheelchair Hand Rim Assembly

(75) Inventor: Russell John Noye, Western Australia (AU)

Correspondence Address: NIXON & VANDERHYE, PC, 901 NORTH GLEBE ROAD, 11TH FLOOR, ARLINGTON, VA, 22203, US

(73) Assignee: NOYE HOLDINGS PTY LTD, Perth, Western Australia (AU)

(21) Appl. No.: 11/995,172

(22) PCT Filed: Jul. 11, 2006
(86) PCT No.: PCT/AU2006/000977

§ 371 Date: Jan. 9, 2008

(30) Foreign Application Priority Data
Jul. 11, 2005 (AU) 2005903655

(51) Int. Cl. A61G 5/10

(52) U.S. Cl. 280/304.1

(57) ABSTRACT

A hand rim assembly to be installed on a wheel rim. The assembly includes a ring member having a base portion, a hand rim portion and a web portion interconnecting the base portion and the hand rim portion. Also provided are a plurality of securing members. The ring member is arranged concentrically with respect to the wheel rim such that the base portion of the ring member engages with a first side surface of the wheel rim. Each securing member includes a first portion arranged to engage with a second opposed side surface of the wheel rim and a second portion arranged to be secured to the base portion of the ring member such that the ring member is secured relative to the wheel rim.

### BACKGROUND OF THE INVENTION

The present invention relates to a hand rim assembly for wheelchair wheels. Wheels on wheelchairs are provided with hand rims that are gripped by the user to rotate the wheel. The most common form of hand rim comprises a simple ring constructed of a tube of circular cross section. The ring is connected to the wheel by a number of tabs extending from the wheel around its circumference.

Wheelchair wheels have also been constructed in which the hand rim comprises a curved flange extending outwardly from the wheel rim around the circumference thereof. The flange is curved to provide a gripping surface generally fitted to the shape of the user's hand to allow a better grip of the hand rim. Such hand rims are generally integrally constructed with the wheelchair wheel or permanently fitted thereto at the time of construction.

The present invention relates to a hand rim assembly that can be retrofit to existing wheelchair wheels in a simple and effective manner. The hand rim assembly can be fit to various types of wheels with differing profiles.

### SUMMARY OF THE INVENTION

In accordance with one aspect of the present invention there is provided a hand rim assembly to be installed on a wheel rim comprising:

a ring member having a base portion, a hand rim portion and a web portion interconnecting the base portion and the hand rim portion; and
a plurality of securing members;
wherein the ring member is arranged concentrically with respect to the wheel rim such that the base portion of the ring member engages with a first side surface of the wheel rim, and each securing member includes a first portion arranged to engage with a second opposed side surface of the wheel rim and a second portion arranged to be secured to the base portion of the ring member such that the ring member is secured relative to the wheel rim.

### BRIEF DESCRIPTION OF THE DRAWINGS

The present invention will now be described, by way of example, with reference to the accompanying drawings, in which:

FIG. 1 is an exploded view of a hand rim assembly in accordance with the present invention;

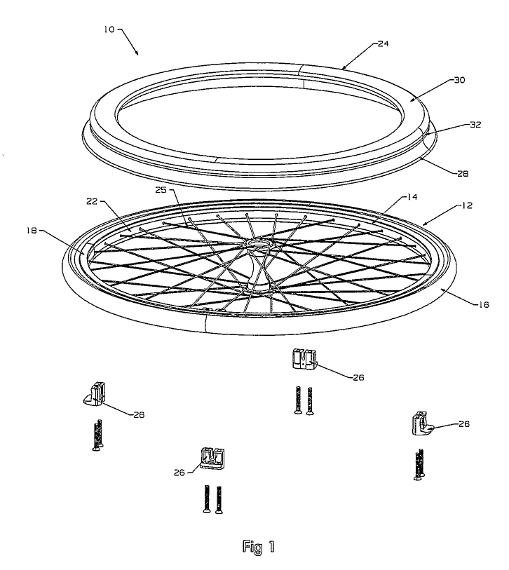

FIG. 2a is a side view of the hand rim of the hand rim assembly of FIG. 1;

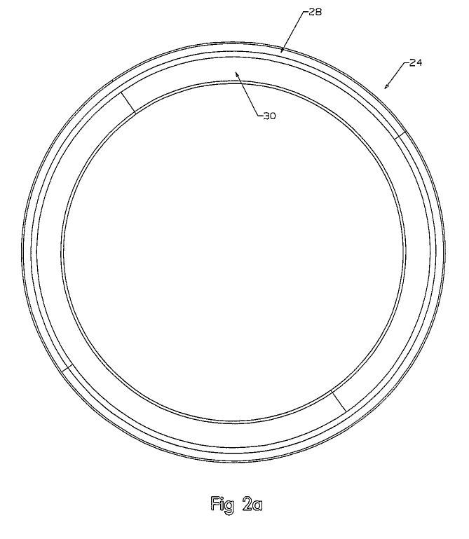

FIG. 2b is a perspective view of the hand rim of FIG. 2a with a portion of the hand rim cut away;

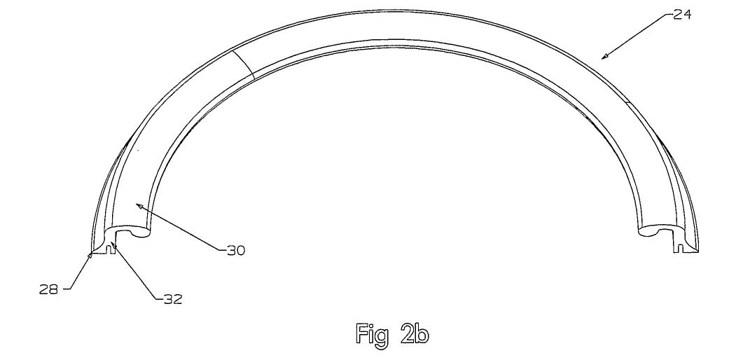

FIG. 3 is a perspective view of a securing means of the hand rim assembly of FIG. 1;

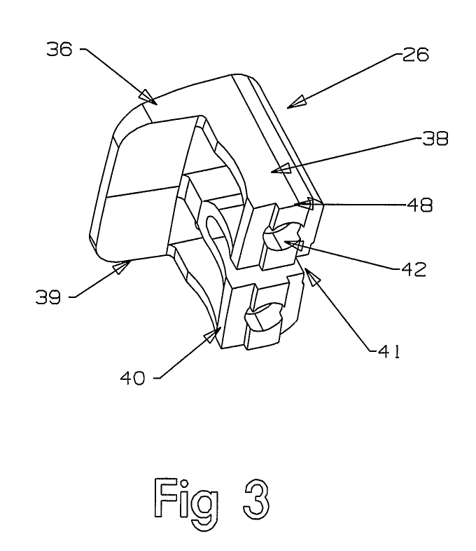

FIG. 4 is an exploded cross sectional view of the securing means and hand rim of the hand rim assembly of FIG. 1;

FIG. 5a is a perspective cut away view of the securing means and hand rim secured to a wheel rim;

FIG. 5b is a side cross sectional view of the securing means and hand rim arranged about the wheel rim prior to installation of a securing screw;

FIG. 6a is a front perspective view of the hand rim assembly of FIG. 1 installed on a wheelchair wheel;

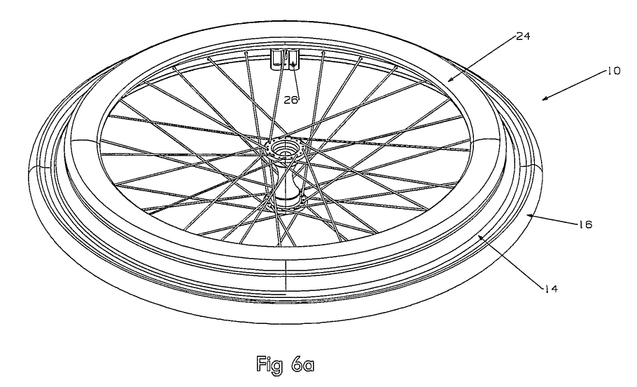

FIG. 6b is the front perspective view of FIG. 6a with a portion of the wheel and hand rim assembly cut away;

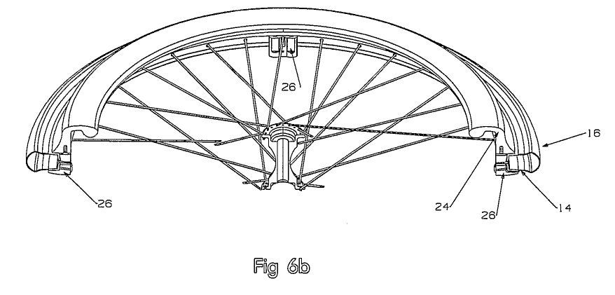

FIG. 6c is a rear perspective view of the hand rim assembly of FIG. 1 installed on a wheelchair wheel;

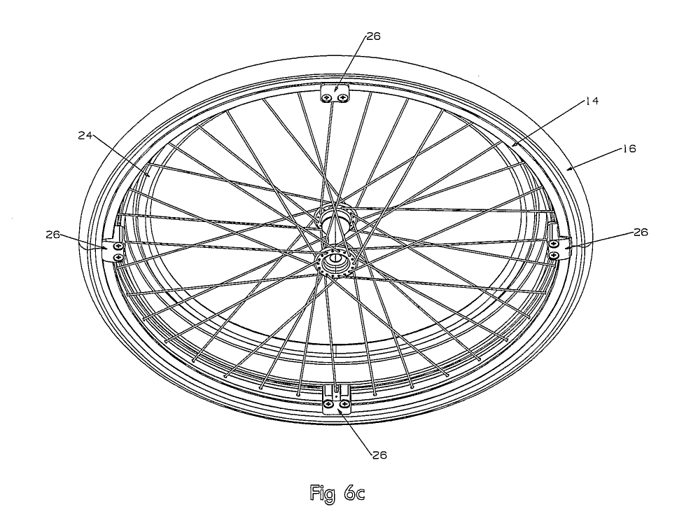

FIG. 7 is an exploded view of a hand rim assembly in accordance with the present invention including a guard member;

FIG. 8 is a front perspective view of the hand rim assembly and guard member of FIG. 7 with portions of the wheel, hand rim assembly and guard member cut away;

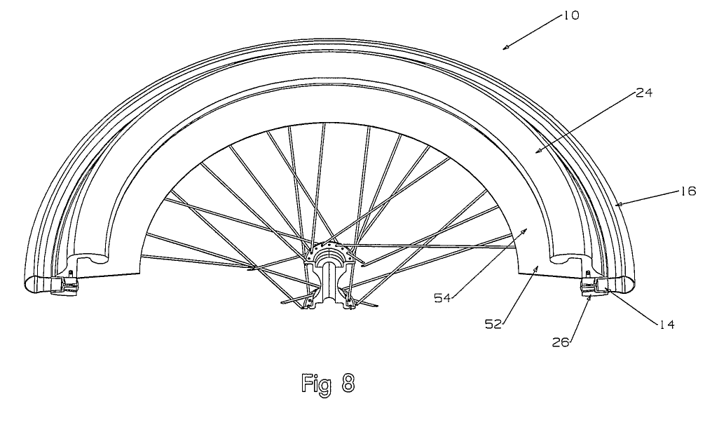

FIG. 9 is a close up of a portion of FIG. 8 showing the securing means;

FIG. 10 is a front perspective view of the hand rim assembly and guard member of FIG. 7 installed on the wheel;

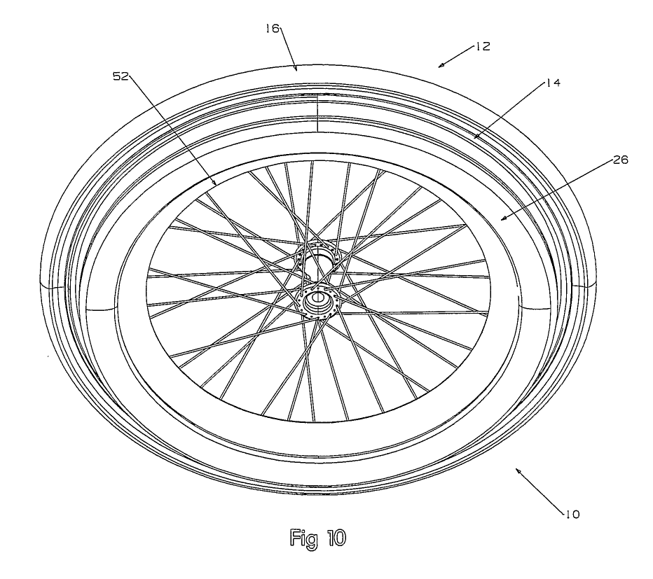

FIG. 11 is a perspective view of an alternative embodiment of the securing means;

FIG. 12 is a perspective view of the securing means of FIG. 11 prior to engagement with the hand rim; and

FIG. 13 is a perspective view of the securing means of FIG. 11 engaged with the hand rim.

### DESCRIPTION OF THE INVENTION

Referring to the Figures, there is shown a hand rim assembly 10 for fitting to a wheel 12 of a wheelchair to provide a hand rim for the user to propel the wheelchair.

The wheel 12 is of a standard construction comprising a wheel rim 14 and a tyre 16. The wheel rim 14 comprises a first side surface 18, a second side surface 20 and an interconnecting surface 22. Each of the first and second side surfaces 18 and 20 are annular shaped surfaces generally parallel to the plane of the wheel 12. The interconnecting surface 22 connects between radially inner edges of the first and second side surfaces 18 and 20 and in the embodiment shown in the Figures is engaged by a plurality of spokes 25 of the wheel 12. The tyre 16 is held between the first and second side surfaces 18 and 20 of the wheel 12 in a known manner.

While embodiment shown in the Figures is employed on a wheel of construction as described above, it will be appreciated that the invention is not limited to use on such a wheel. The invention may also be employed on composite wheels and is not necessarily limited to use on spoked wheels as shown.

The hand rim assembly 10 comprises a ring member 24 and a plurality of securing members 26. The ring member 24 is arranged to be concentrically secured to the wheel rim 14 by the securing members 26.

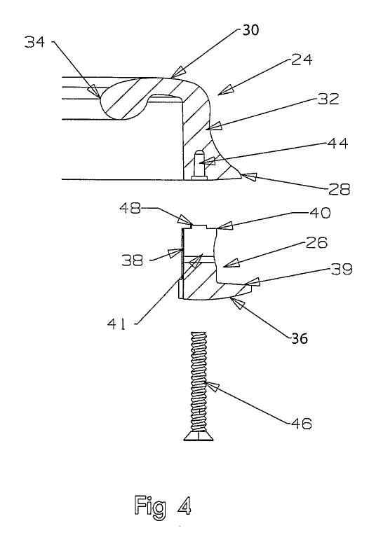

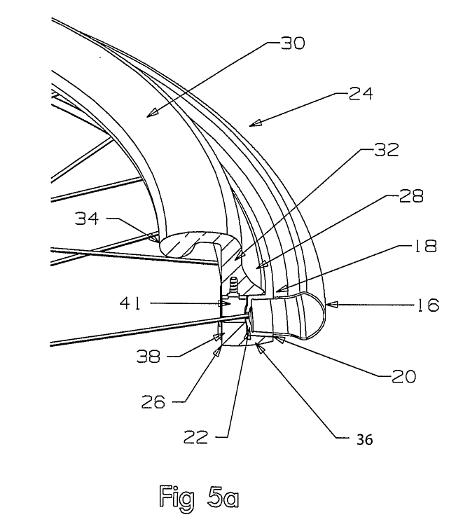

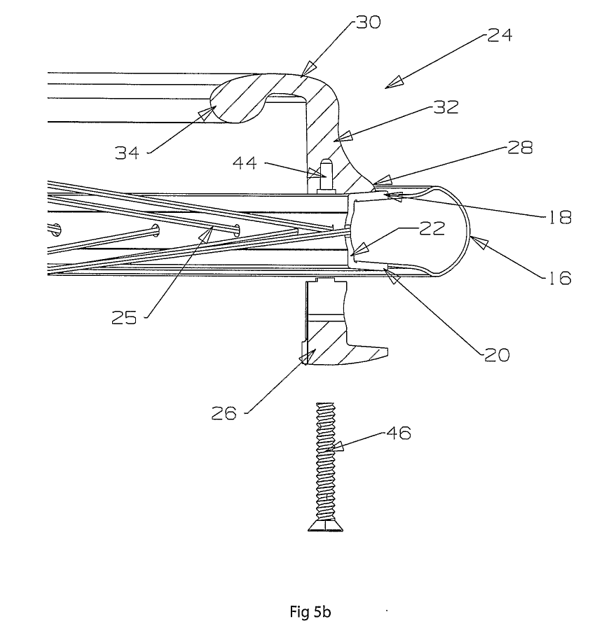

Referring to FIG. 4, the ring member 24 comprises a base portion 28, a hand rim portion 30 and an interconnecting web portion 32. The base portion 28 is generally annular in shape and has an outer radius greater than the inner radius of the wheel rim 14 and an inner radius less than the inner radius of the wheel rim 14. Therefore when the base portion 28 is engaged against the first side surface 18 of the wheel rim 14, a portion of the base portion 28 extends radially inward of the wheel rim 14, as can be seen in FIG. 5a.

The web portion 32 extends from the radially inner edge of the base portion 28 in a direction generally parallel to the rotational axis of the wheel 12. The web portion 32 therefore is generally cylindrical in shape, wherein the central axis of the cylinder is coincident with the rotational axis of the wheel 12. The hand rim portion 30 and the web portion 32 are the portions that are gripped by the user of the wheelchair and used to rotate the wheel 12, thereby propelling the wheelchair. The hand rim portion 30 extends radially inwardly from an edge of the web portion 32 remote from the wheel 12. The hand rim portion 30 is shaped to be easily grasped by the user for most effective use. The radial cross section of the hand rim portion 30 therefore preferably has bulbous distal end 34, as can be seen in FIG. 4. The profile of the ring member 24 however may be modified as desired without departing from the present invention.

The hand rim assembly 10 is provided with a plurality of securing members 26 to secure the ring member 24 to the wheel rim 14. Each of the securing members 26 includes a first portion 36 and a second portion 38. The first portion 36 includes a surface 39 arranged to engage against the second side surface 20 of the wheel rim 14. The second portion 38 extends generally transversely to the first portion 36 such that when the surface 39 is engaged against the second side surface 20, the second portion 38 extends adjacent and parallel to the interconnecting surface 22 of the rim 14. The second portion 38 includes an end 40 remote from the first portion 36 that, in use, engages with the base portion 28 of the ring member 24.

In the embodiment shown, the second portion 38 of the securing member 26 includes a pair of apertures 42 running the length of the second portion 38. A circumferential groove 44 is provided in the base portion 28 of the ring member 24 such that screws 46 are inserted through the apertures 42 and into the circumferential groove 44. Tightening of the screws 46 pulls the securing member 26 and the ring member 24 toward each other thus clamping the hand rim assembly 10 to the wheel rim 14.

The end 40 of each of the securing members 26 may also be provided with a protruding ridge 48 running in a direction tangential to the ring member 24 such that the ridge 48 may be received in the circumferential groove 44 in the base portion 28 of the ring member 24 to aid in locating the securing member 26 relative to the ring member 24. The second portion 38 of each of the securing members 26 includes a slot 41 extending from the end of the second portion 38 toward the first portion 36. The slot 41 is arranged to receive one of the spokes 25 of the wheel 12 when the securing member 26 is secured to the wheel rim 14. In this way, lateral movement of the securing member 26 and therefore of the ring member 24 is prevented.

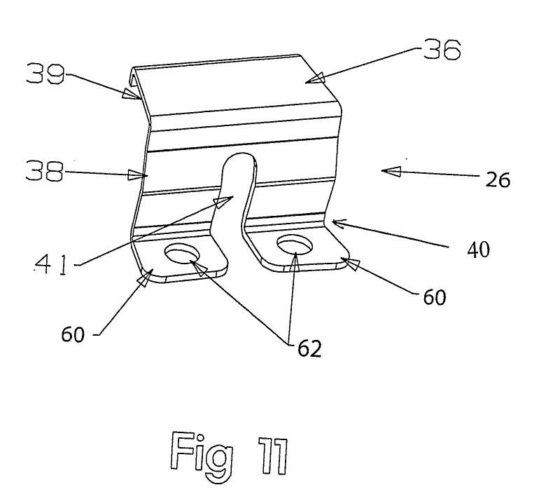

FIGS. 11 to 13 show an alternative embodiment of a securing member 26 in accordance with the present invention where like numerals are used to denote like parts. In the embodiment shown in FIGS. 11 to 13, the first and second portions 36 and 38 of the securing member 26 are constructed of relatively thin sheet material. The end 40 of the securing member 26 is provided with a pair of tabs 60. The tabs 60 extend generally perpendicular to the second portion 38 of the securing member, one from each side of the slot 41.

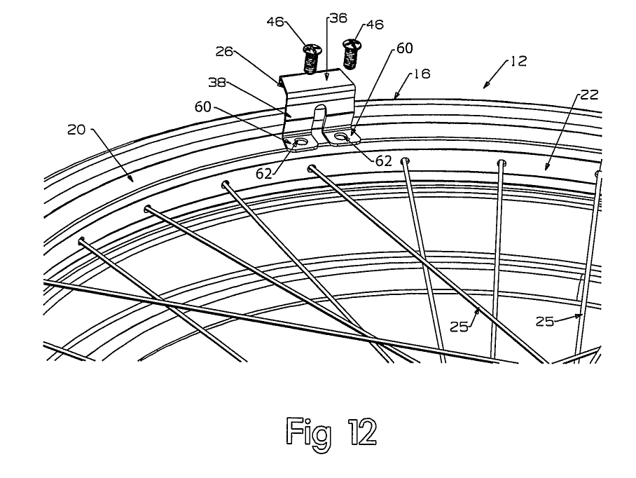

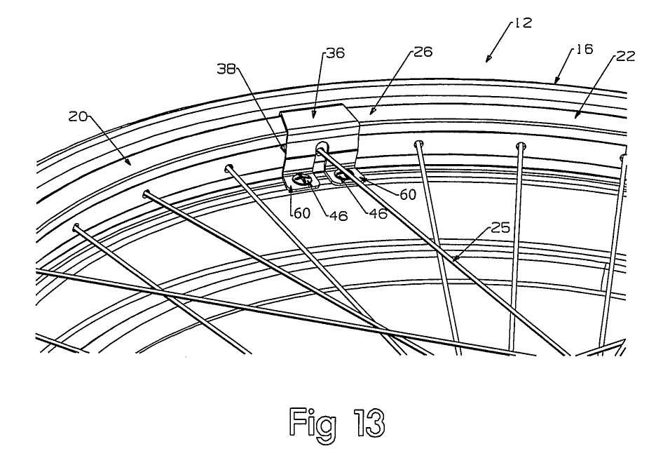

The tabs 60 each include a hole 62 located such that when the securing member 26 is placed with the first portion 36 engaging the second surface 20 of the rim 14, the holes 62 align with the groove 44. Screws 46 are then inserted through the holes 62 into the groove 44 as shown in FIGS. 12 and 13 in order to secure the securing means 26 to the ring member 24 and thereby secure the ring member 24 to the wheel rim 14.

In use, a plurality of securing members 26 are provided around the wheel rim 14 to evenly secure the ring member 24 to the wheel rim 14. Preferably the securing members 26 are provided at regular angular spacings around the circumference of the wheel rim 14.

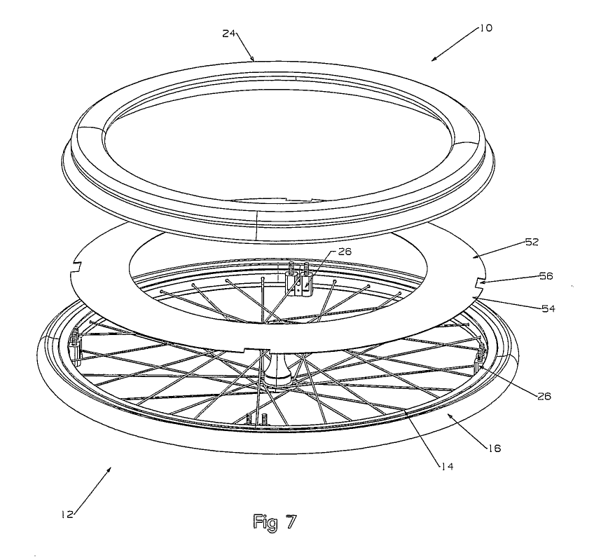

The hand rim assembly 10 may also be provided with a guard member 52 as can be seen in FIG. 7. The guard member 52 comprises an annular disc 54 arranged to be secured between the ring member 24 and the first side surface 18 of the wheel rim 14. The guard member 52 extends inwardly from the wheel rim 14 covering the spokes 25 such that the user is prevented from catching their hands in the spokes 25.

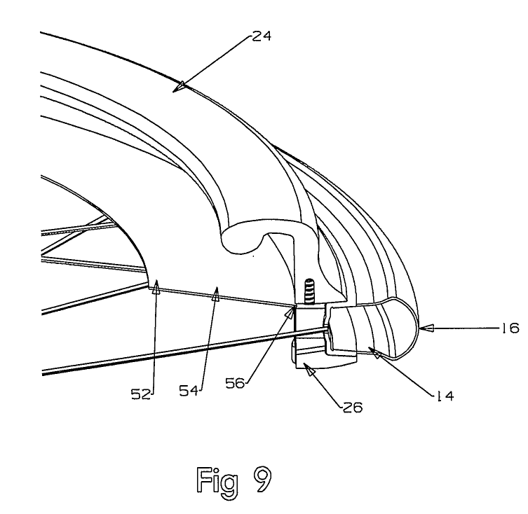

The guard member 52 includes a plurality of notches 56 around the periphery thereof corresponding to the intended location of the securing member 26. The notches 56 receive the second portions 38 of the securing members 26 as shown in FIG. 9. The engagement of the securing members 26 with the notches 56 also prevents rotational movement of the guard member 52 relative to the wheel rim 14 and other elements of the hand rim assembly 10. Further, the guard member 52 as shown also locates into the circumferential groove 44 of the ring member 24, preventing foreign objects entering the circumferential groove 44 in use. In the case where the guard member 52 is not used, a separate cover (not shown) may be employed for this purpose. Modifications and variations as would be apparent to a skilled addressee are deemed to be within the scope of the present invention. For example, the mechanism of attachment of the securing members 26 to the ring member 24 is not limited to a screw connection but may be via clips, tacks or any other suitable securing mechanism. Also, the circumferential groove 44 may be replaced by a plurality of holes around the ring member. Further, the shape and design of the securing member 26 may be varied to accommodate a variety of wheels and rims.

1. A hand rim assembly to be installed on a wheel rim, the hand rim-assembly comprising:
a ring member having a base portion, a hand rim portion and a web portion interconnecting the base portion and the hand rim portion; and
a plurality of securing members;
wherein the ring member is arranged concentrically with respect to the wheel rim such that the base portion of the ring member engages with a first side surface of the wheel rim, and
each securing member includes a first portion arranged to engage with a second opposed side surface of the wheel rim and a second portion arranged to be secured to the base portion of the ring member such that the ring member is secured relative to the wheel rim.

2. A hand rim assembly in accordance with claim 1, wherein the wheel rim includes an interconnecting surface extending from the first side surface to the second side surface and
the second portion of the securing member extends generally perpendicular to the first portion of the securing member such that when the first portion engages with the first side surface of the wheel rim, the second portion extends adjacent and parallel to an interconnecting surface.

3. A hand rim assembly in accordance with claim 1, wherein at least one aperture is provided extending through a length of the second portion and at least one corresponding screw is provided such that the screw is inserted through a corresponding apertures and engages with the base portion of the ring member, thereby securing the second portion of the securing member to the base portion.

4. A hand rim assembly in accordance with claim 1, wherein the second portion is provided with at least one hole provided on a tab extending transversely from an end the second portion remote from the first portion, and at least one corresponding screw is provided such that the screw is inserted through hole and engages with the base portion of the ring member, thereby securing the second portion of the securing member to the base portion.

5. A hand rim assembly in accordance with claim 3, wherein the base portion of the ring member is provided with a circumferential groove and the screw is received in the groove to engage with the base portion.

6. A hand rim assembly in accordance with claim 1, wherein the wheel rim includes a plurality of spokes and the second portion of each securing member is provided with a slot for receiving one of the spokes when the securing member is engaged with the ring member.

7. A hand rim assembly in accordance with claim 1 wherein that the base portion of the ring member is annular in shape and has an outer radius greater than an inner radius of the wheel rim, and the ring member has an inner radius less than the inner radius of the wheel rim.

8. A hand rim assembly in accordance with claim 7, wherein an interconnecting web portion is generally cylindrical in shape and extends from a radially inner edge of the base portion in a direction parallel to a rotational axis of the wheel.

9. A hand rim assembly in accordance with claim 8, wherein the hand rim portion extends radially inward from an outer edge of the web portion.

10. A hand rim assembly in accordance with claim 9, wherein a cross sectional shape of the hand rim portion includes a bulbous distal end.

11. A hand rim assembly in accordance with claim 1, including a guard member securable between the base portion and the first side surface of the wheel rim and extending radially inward of the base portion.

12. A hand rim assembly in accordance with claim 11, wherein the guard member comprises an annular disc including a plurality of notches in an outer periphery of the guard member for receiving the second portion of a corresponding securing member.
